(19) United States
(12) Patent Application Publication
(10) Pub. No.: US 2013/0010013 A1
(43) Pub. Date: Jan. 10, 2013

(54) DISPLAY METHOD AND DISPLAY DEVICE

(75) Inventors: Yi LI, Shenzhen (CN); Yi YANG, Shenzhen (CN)

(73) Assignee: APPOTRONICS CORPORATION LIMITED, Shenzhen (CN)

(21) Appl. No.: 13/620,248

(22) Filed: Sep. 14, 2012

Related U.S. Application Data
(63) Continuation of application No. PCT/CN2011/071972, filed on Mar. 18, 2011.

(30) Foreign Application Priority Data
Mar. 18, 2010 (CN) 201010128490.5

(51) Int. Cl. G09G 5/10

(52) U.S. Cl. 345/690

(57) ABSTRACT

The present invention relates to a display method and a display device. The display method comprises the following steps: a display screen provided with an optical wavelength conversion layer receives an exciting light which is projected by at least one projection device and carries image information; every projection pixel of an image carried by the exciting light corresponds to a unit optical wavelength conversion material in a series of repeating units which are arranged on the optical wavelength conversion layer according to a predetermined rule; and the exciting light excites the corresponding optical wavelength conversion materials in the repeating units to produce an excited light, and the image is reproduced in the display screen based on every repeating unit. Due to the modulation of a projection light source, the display brightness of the screen can be enhanced and seams of the image can be eliminated.

### CROSS-REFERENCE TO RELATED APPLICATIONS

This application is a continuation of International Application No. PCT/CN2011/071972, filed on Mar. 18, 2011, which claims the priority benefit of China Patent Application No. 201010128490.5, filed on Mar. 18, 2010. The contents of the above identified applications are incorporated herein by reference in their entirety.

### FIELD OF THE TECHNOLOGY

The present invention relates to the technical field of image display, in particular to an image display method and a display device for a large screen for producing images and/or realizing image splicing by exciting an optical wavelength conversion material with a light source.

### BACKGROUND

With the increasing expansion of monitoring and outdoor display markets, the wall splicing technology for realizing large-screen display is increasingly developed and perfected.

A liquid crystal wall splicing scheme and a back projection wall splicing scheme are mainly adopted in the current wall splicing technology. A plurality (for example but not limited in 2×2) of liquid crystal televisions or a plurality of back projection display units are arranged together to form a large screen for displaying an image or continuous images. The main problem of liquid crystal wall splicing lies in that inevitable seams are produced between the liquid crystal televisions, the width of the seams of the current popular products is generally 5 to 7 millimeters. When liquid crystal televisions are used for monitoring, certain key monitoring information such as vehicle licenses, faces and the like at the seams may be missed. The splicing seams of back projection wall splicing can be reduced to 1 millimeter at the best, but still cannot be completely eliminated, and continuous change of brightness and color is difficult to be realized at the seams of the screen, namely mutation in brightness and/or color occurs at two edges of the seams, so that the visual effect is adversely affected.

The following method has been adopted to eliminate the seams in the conventional plasma display screen, namely based on the luminous area of a sacrificial part, the width of the pixel clearance between adjacent pixels is artificially increased, so that the width of the pixel clearance is close to that of the seam between the plasma display screens, the spliced image of the plasma display screens has a uniform display picture effect, and the frame feeling of the image is eliminated achieving seamless splicing of large screens. This scheme fails to fundamentally solve the problem of missing information caused by the seams, meanwhile a part of luminous area is sacrificed, and the scheme is not favorable for viewing the image in a short distance.

The defects of the prior art are mainly resulted from the structure and the display principle of the large screen. For a projector, images from the front side can only be viewed by human eyes after being scattered and reoriented by the screen. Therefore, the screen of a projector must comprise a Fresnel lens for implementing scattering and reorientation. The Fresnel lens is provided with concentric threads, and the luminous optical axis of the projection light source must correspond to the circle center of the concentric threads, so one screen can only correspond to one projection light source. However, the brightness of one projector is limited, which undoubtedly does not allow the screen of a projector to be made too large. Therefore, for realizing a large screen, a screen splicing technology and a high-brightness projection light source must be used. Based on the principle, the brightness of projection on a screen has the distribution characteristics that the center is brightest and four corners are darkest, so that brightness consistency at the seams is difficult to control, directly resulting in brightness mutation at the seams.

Meanwhile, the large screen in the prior art also has the defects that the structure is complex, the technical difficulty is high, the selling price is high and the light transmittance is only about 60 percent.

### SUMMARY

The present invention mainly aims to provide a display method and a display device for solving the brightness or color non-uniformity problem at screen seams.

For fulfilling the aim, the present invention provides a display method, comprising the following steps:

a display screen provided with an optical wavelength conversion layer receives an exciting light which is projected by at least one projection device and carries image information; every projection pixel of an image carried by the exciting light corresponds to one unit of optical wavelength conversion material in a series of repeating units arranged on the optical wavelength conversion layer according to a predetermined rule;
and the exciting light excites the corresponding optical wavelength conversion materials in the repeating units to produce an excited light, and the image is reproduced in a display region of the display screen based on the repeating unit and an array consisting of the repeating units.

Preferably, the method further comprises: a first optical filter in the optical path between the projection device and the display screen is used to transmit the light produced by the projection device and reflect the excited light from the optical wavelength conversion layer; and/or a second optical filter on the opposite side of the display screen relative to the first optical filter is used to reflect the exciting light from the projection device and transmit the excited light from the optical wavelength conversion layer.

Preferably, the method further comprises: the exciting light is focused by a micro lens array located in the optical path between the projection device and the optical wavelength conversion layer to at least one repeating unit through a corresponding micro lens, and the excited light from the optical wavelength conversion layer is reflected by an optical reflection material or a reflection film which is coated or stuck to one side of the micro lens array facing the optical wavelength conversion material.

Preferably, the method further comprises: the exciting light is focused by a diaphragm located in the optical path between the projection device and the optical wavelength conversion layer to at least one corresponding repeating unit, and the excited light from the optical wavelength conversion layer is reflected by a reflection surface on one side of the diaphragm facing the optical wavelength conversion layer.

Preferably, the brightness information of every projection pixel of the image carried by the exciting light is controlled through an optical valve in the projection device and used for determining the brightness of the excited light of the corresponding optical wavelength conversion material in the repeating unit.

Preferably, when the number of the projection devices is two or more, the exciting light of every projection device is respectively projected to the same display region of the display screen; or the exciting light of every projection device is respectively projected to a local part of the display screen, and images reproduced on the local parts are spliced or superposed into an image.

Preferably, the display brightness of the display screen is calculated according to a predetermined algorithm, so that the display brightness linearly or nonlinearly changes in the centrifugal direction of the center of a circumscribed circle of the projection range.

Preferably, the method further comprises a calibration process of the exciting light of the projection device, wherein the calibration process comprises the following steps:

a color or a brightness of the reproduced image in the projection region of the display screen generated by the projection device is acquired by using an optical sensor; the color or the brightness is supplied to a signal analysis processor for calculating;
a light intensity distribution requirement of a projection light source of the projection device is determined according to the calculating result; and
a power supply source or a signal source supplied to the projection light source is controlled according to the light intensity distribution requirement.

Preferably, the method further comprises a calibration process of a spatial position of the projection device, wherein the calibration process comprises the following steps:

a color or a brightness of the reproduced image in the projection region of the display screen generated by the projection device is acquired by using an optical sensor;
the color or the brightness is supplied to a signal analysis processor for calculating;
and a spatial offset of the projection device is determined according to the calculating result, and the projection device is moved a small distance till the calculating result meets the requirement.

The present invention further provides a display device, comprising a display screen and at least one projection device, wherein the projection device projects the exciting light which carries image information to a display screen, the display region of the display screen is provided with an optical wavelength conversion layer, at least one type of optical wavelength conversion material which, when being excited by the exciting light, produces a visible excited light is arranged on the optical wavelength conversion layer, and the optical wavelength conversion materials are arranged according to a predetermined rule to form a series of repeating units for reproducing images on the display region.

Preferably, the display device further comprises a first optical filter arranged in the optical path between the projection device and the display screen and used for transmitting the exciting light produced by the projection device and reflecting the excited light from an optical wavelength conversion layer; and/or a second optical filter arranged on the opposite side of the display screen relative to the first optical filter and used for reflecting the exciting light from the projection device and transmitting the excited light from the optical wavelength conversion layer.

Preferably, the display device further comprises a micro lens array located in the optical path between the projection device and the optical wavelength conversion layer; the exciting light is focused by the micro lens array to at least one repeating unit through a corresponding micro lens, and an optical reflection material or a reflection film is coated or stuck to one side of the micro lens array facing the optical wavelength conversion material.

Preferably, the display device further comprises a diaphragm which is adjacent to the display screen and is arranged in the optical path between the projection device and the optical wavelength conversion layer; open pores are periodically arranged on the diaphragm and used for respectively corresponding to at least one repeating unit of the optical wavelength conversion material; and one side of the diaphragm facing the optical wavelength conversion layer is a reflection surface.

Preferably, the projection device is a projector using a blue light emitting diode (LED) and/or ultraviolet LED and/or blue laser and/or ultraviolet laser as a light source.

Preferably, when the number of the projection devices is two or more, the exciting light of every projection device is respectively projected to the same display region of the display screen; or the exciting light of every projection device is respectively projected to a local part of the display screen, and images reproduced on the local part are spliced or superposed into an image.

Preferably, the repeating units are periodically expanded and repeated in two mutually orthogonal directions on the optical wavelength conversion layer.

Preferably, a black light absorption material is filled among the repeating units or among different grids or strips in the repeating units.

Preferably, when the exciting light of the projection device is blue light, the grid or the strip marked for bearing blue light in every repeating unit is a transparent substrate or/and a scattering material.

Preferably, the display device further comprises at least one moving device which is connected and attached to the projection device and used for precisely adjusting relative spatial positions of the projection device and the display screen.

Preferably, the display screen is provided with a substrate made of a flexible material.

### BRIEF DESCRIPTION OF THE DRAWINGS

FIG. 1 is a structural schematic diagram of a display device according to an embodiment of the invention;

FIG. 2 is a schematic diagram of projection mode I where the display device is provided with two projection devices according to an embodiment of the invention;

FIG. 3 is a schematic diagram of projection mode II where the display device is provided with two projection devices according to an embodiment of the invention;

FIG. 4a is a three-dimensional structural schematic diagram of an optical wavelength conversion layer on a display screen according to an embodiment of the invention;

FIG. 4b is a schematic diagram of a first arrangement mode of the optical wavelength conversion material on the display screen according to an embodiment of the invention;

FIG. 4c is a schematic diagram of a second arrangement mode of the optical wavelength conversion material on the display screen according to an embodiment of the invention;

FIG. 4d is a schematic diagram of a third arrangement mode of the optical wavelength conversion material on the display screen according to an embodiment of the invention;

FIG. 4e is a schematic diagram of a fourth arrangement mode of the optical wavelength conversion materials on the display screen according to an embodiment of the invention;

FIG. 4f is a schematic diagram of a fifth arrangement mode of the optical wavelength conversion materials on the display screen according to an embodiment of the invention;

FIG. 4g is a schematic diagram of a sixth arrangement mode of the optical wavelength conversion materials on the display screen according to an embodiment of the invention;

FIG. 4h is a schematic diagram of a seventh arrangement mode of the optical wavelength conversion materials on the display screen according to an embodiment of the invention;

FIG. 5 is a structural schematic diagram of a calibration control structure of the display device according to an embodiment of the invention;

FIG. 6 is a structural schematic diagram of a display screen with a micro lens array of the display device according to an embodiment of the invention;

FIG. 7 is a schematic flow diagram of a display method according to an embodiment of the invention;

FIG. 8 is a flow diagram of a calibration process for calibrating exciting light of each projection device in the display method according to an embodiment of the invention;

FIG. 9 is a flow diagram of a calibration process for calibrating the spatial position of each projection device in the display method according to an embodiment of the invention.

The implementation, functional characteristics and advantages of the invention will be further illustrated with reference to the drawings.

### DETAILED DESCRIPTION

The technical scheme for fulfilling the aim of the invention is detailed with reference to the drawings and embodiments. It should be understood, the embodiments described here are only used for illustrating the invention rather than limiting the invention.

As known by those skilled in the art, the letters “B”, “G” and “R” used in the accompanying diagrams are standard color codes, wherein “B” represents blue color, “G” represents green color, and “R” represents red color; and forming different colors and tons based on combination of the standard colors belongs to the prior art and is not detailed here.

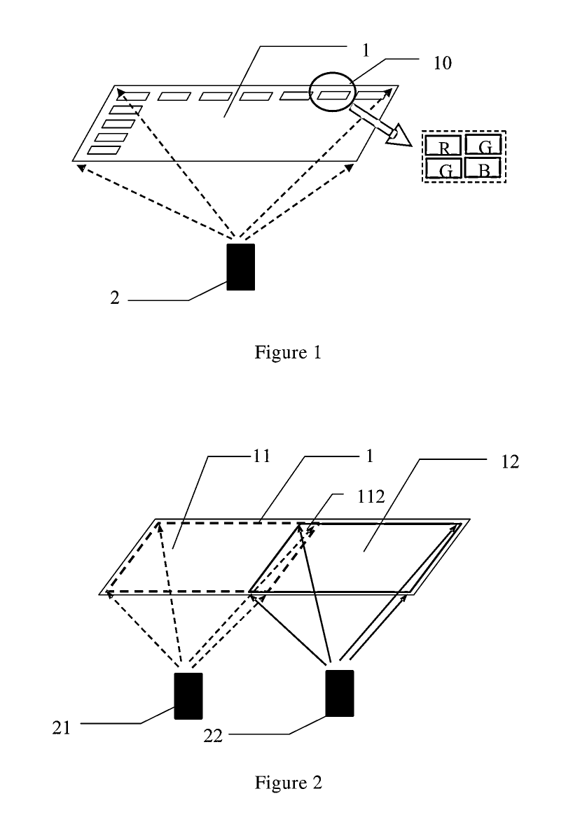

As shown in FIG. 1, the display device according to an embodiment of the invention comprises a display screen 1 and a projection device 2, the projection device 2 projects exciting light which carries image information to the display screen 1. The image information comprises brightness information of every projection pixel of an image to be projected (in this embodiment the projection pixels are defined as the pixels carried by the exciting light projected by the projection device 2; and the screen display pixels are defined as the pixels reproduced in the display screen 1).

The display region of the display screen 1 is provided with an optical wavelength conversion layer, at least one type of optical wavelength conversion material able to generate a visible excited light (such as red light, blue light or green light) when being excited by the exciting light is arranged on the optical wavelength conversion layer, and the optical wavelength conversion material is arranged according to a predetermined mode to form a series of repeating units, shown as a unit 10. Every repeating unit 10 can be as shown in the amplified part in FIG. 1, comprising four minimum units of a 2×2 grid array, wherein two grids at diagonal positions are provided with optical wavelength conversion materials for generating the green light (G), and the other two grids are provided with optical wavelength conversion materials for generating other color light (such as red light R or blue light B).

Every projection pixel of the image carried by the exciting light corresponds to one grid (namely one minimum unit) of the optical wavelength conversion material in a series of repeating units on the optical wavelength conversion layer, and particularly, every projection pixel corresponds to one grid of optical wavelength conversion material of the repeating units. Conversely, when the display device is provided with one projection device, every grid of optical wavelength conversion material of the repeating units corresponds to one projection pixel of the projection device; when the display device is provided with a plurality of projection devices, every grid of optical wavelength conversion material of the repeating units may correspond to a plurality of projection pixels of the plurality of projection devices (such as a situation that a plurality of projection devices make projection to a certain local region of the display screen, respectively).

When the exciting light excites the corresponding optical wavelength conversion material in respective repeating unit, a visible excited light is generated, and an image is reproduced in the display region of the display screen 1 based on respective repeating unit and an array consisting of the repeating units. The brightness information of every projection pixel of the image carried by the exciting light is controlled through an optical valve in the projection device 2 (the optical valve control technology belongs to prior art, and is not detailed here), so that the brightness of the excited light of the corresponding optical wavelength conversion material in the repeating unit can be determined. Because every grid of optical wavelength conversion material of the repeating unit is predetermined and unchanged, the color of every grid is further determined; meanwhile, the brightness of every grid of optical wavelength conversion material is directly proportional to the intensity of the excited light on the optical wavelength conversion material, the intensity of the exciting light of every projection pixel (namely a small beam of exciting light corresponding to every projection pixel in the exciting light projected by the projection device) of the projection device can be controlled through the optical valve, and the brightness of the excited light of the optical wavelength conversion material of the corresponding excited grid of the repeating unit is further controlled, namely the brightness of every grid of optical wavelength conversion material in the repeating unit is controllable. Because each grid of the repeating unit is small in size, the color and the brightness of every grid of optical wavelength conversion material in the repeating unit are difficult to distinguish by human eyes, and to human eyes, the color of each repeating unit is the superposition of the color and the brightness of every grid of optical wavelength conversion material in the repeating unit. Therefore, according to the optical superposition principle, as long as the color and the brightness of every grid of optical wavelength conversion material are respectively controlled through certain algorithms, the color and the brightness of the corresponding repeating unit consisting of a plurality of optical wavelength conversion material grids can be realized, and the color image of the whole displayed image is further controlled.

On one side of the display screen 1, each screen display pixel of the reproduced image in the display region of the display screen 1 corresponds to one repeating unit. Take repeating unit 10 as an example, it comprises four grids of optical wavelength conversion materials correspondingly used for generating color light; and in the exciting light carrying the brightness information of four projection pixels from the projection device 2, every small beam of exciting light carrying the brightness information of one projection pixel corresponds to a corresponding grid of optical wavelength conversion material in the excited repeating unit. Equivalently, a screen display pixel of the color image on the display screen 1 is realized by using the four projection pixels of the exciting light of the projection device 2.

Certainly, the situation that the exciting light corresponding to a part of projection pixels is projected beyond the optical wavelength conversion layer may occur, the imaging effect on the display screen is correspondingly affected, and this situation as a variant of the embodiment should be within the protection range of the invention.

In the embodiment, the optical wavelength conversion material comprises fluorescent powder, quantum dots or dye, and currently fluorescent powder is used more often.

In the embodiment of FIG. 1, the display screen 1 can have a substrate made of a flexible material, or a nonflexible transparent substrate as used in the prior art; and various small fluorescent powder blocks are printed on the transparent substrate according to a certain rule to form the screen. The screen is random in size and manufactured as required. The projection device is placed on one side of the display screen 1, and the exciting light modulated by the light valve comprises brightness information of every projection pixel of an image and corresponds to every small fluorescent powder block, so that the brightness of the excited light of every small fluorescent powder block is controlled; and on the opposite side of the display screen 1, the brightness of the excited light of the repeating units produced by a plurality of small fluorescent powder blocks is determined. Therefore, the array of the repeating units on the display region can well reproduce a color image.

By taking the arrangement rule of the fluorescent powders on the repeating unit 10 as an example, equivalently a screen display pixel of the color image on the display screen 1 is realized by using the four projection pixels of the projected exciting light, so the resolution of the image displayed by the display screen 1 in the horizontal and vertical directions is respectively halved.

On the occasions with high image resolution requirement, for overcoming the defects of the above embodiment, the display device of the invention can comprise two or more projection devices 21 and 22. As shown in FIG. 2, by using two projection devices 21 and 22 as an example, the exciting light of the projection devices 21 and 22 is respectively projected to regions 11 and 12 of the display screen 1, for example, the exciting light of the first projection device 21 is projected to the first region 11, the exciting light of the second projection device 22 is projected to the second region 12, and images reproduced on the regions 11 and 12 are spliced (the crossed region 112 of the regions 11 and 12 is small and can be omitted) or superposed into an image. Furthermore, for original images with high resolution, because the number of the projection devices 21 and 22 and the display region of the whole display screen 1 can be expanded almost without limitation, excessive loss of the final resolution of the images displayed on the display screen 1 can be avoided by increasing the number of projection devices. Therefore, when a large screen is used for displaying, the images can have high resolution.

Under such situation, the area of the superposed part of the two local regions 11 and 12 is preferably lower than 20 percent of the area of the smaller one of the two local regions, so that high image splicing efficiency is achieved. For avoiding splicing “traces”, the projection edge of at least one projection device 21 or 22 on the display screen can be curved, so that a directly spliced line which is easily sensed by human eyes does not exist in splicing. The edge can be determined as a line formed by connecting pixels whose brightness is less than or equal to 5 percent of the central brightness on the display screen 1 when the projection device is separately lightened to show uniform images. For achieving a good splicing effect, the display brightness of the display screen 1 can be designed according to a predetermined algorithm, for example, under the condition that the separate uniform light is lightened, the display brightness of the display screen 1 linearly or nonlinearly changes in the centrifugal direction of the center of the circumscribed circle of the projection range; therefore, when the edge changes of the adjacent parts are opposite, the splicing “traces” are faded as much as possible.

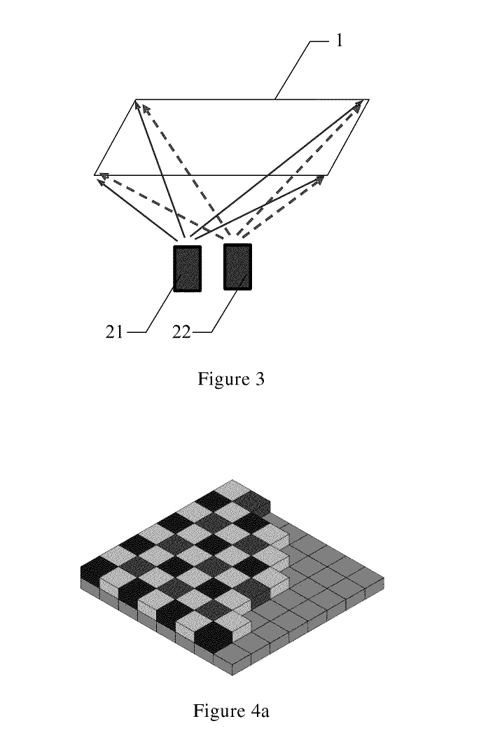

In addition, the display device can further be used for increasing the brightness of the images on the display screen as required, for example, as shown in FIG. 3, the exciting light of the projection device 21 and the exciting light of the projection device 22 are respectively projected to the same display region of the display screen 1, so that the exciting light of the projection device 21 and the exciting light of the projection device 22 are superposed to achieve the effect of brightening screen display. Or when the number of the projection devices is more than two, the area of the superposed part of any two local regions is more than 50 percent of the area of the smaller one of the two local regions, as shown in FIG. 2, when the area of the crossed region 112 is larger than half of the first region 11, the effect of brightening the screen can further be effectively achieved.

In the embodiment, the projection device can be a projector as used in the prior art, and particularly, a monochromatic projector can save cost. By considering the situation that efficient exciting light is supplied to fluorescent powders, the projection device is preferred to be a monochromatic projector using blue light or ultraviolet light as a light source, and particularly, an LED light source can be conveniently controlled in real time; and when the requirement for the light diffusion angle is extremely high, laser can be considered as a light source. The light energy of the exciting light supplied to the display screen by the projection light source in the wavelength range of 250 to 500 nanometers is more than 80 percent of that of the exciting light in the whole wavelength area range, so that the excited efficiency of the fluorescent powders is improved. According to an example facilitating economical implementation, the exciting light is set as blue light of which main wavelength is 440 to 470 nanometers or ultraviolet light of which peak wavelength is 390 to 420 nanometers.

Certainly, in the presence of a plurality of projection devices, the projection devices can be one or two or combination of projectors using blue light LEDs, ultraviolet LEDs, blue laser and ultraviolet laser as light sources.

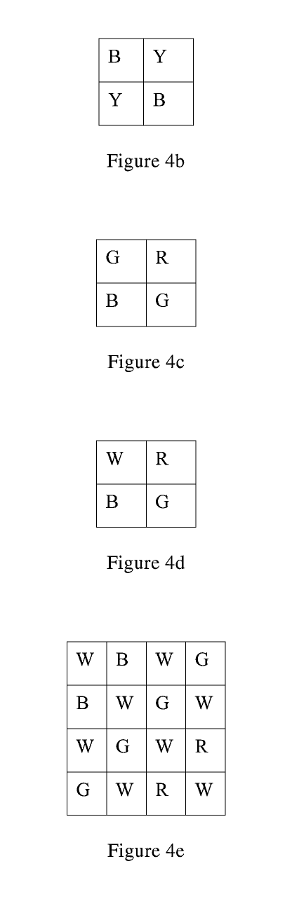

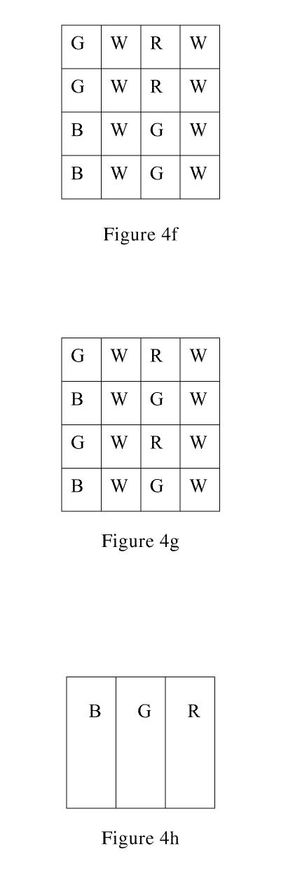

Furthermore, FIG. 4 illustrates a plurality of arrangement modes of the optical wavelength conversion materials in every repeating unit. FIG. 4a shows the structure of an optical wavelength conversion layer, and FIGS. 4b-4h show the arrangement of optical wavelength conversion materials in one repeating unit (display pixel) in the optical wavelength conversion layer, wherein B, Y, G, R and W respectively represent the optical wavelength conversion materials, when excited, to produce blue light, yellow light, green light, red light and white light, such as fluorescent powders. In the embodiment of FIG. 4b, the repeating unit comprises four grids forming a 2×2 array, and the four grids are divided into two units for bearing blue fluorescent powder and yellow fluorescent powder respectively by using two diagonal grids as a unit. When the exciting light of the projection device is blue light, the unit marked for bearing the blue fluorescent powder (B) in the repeating unit does not have any optical wavelength conversion material, and is a transparent substrate or/and a scattering material (such as a scattering powder coating or a scattering film). The display screen planned by the embodiment of FIG. 4b is designed to display black and white images. In the black-white display screen, the repeating unit can have a strip array using two strips as a period, at least one strip is provided with the optical wavelength conversion material for exciting yellow light in one period, and at least one strip does not have any optical wavelength conversion material or is not provided with a scattering material.

Likewise, by adopting the 2×2 array, the display screen formed by the repeating units of FIGS. 4c and 4d are designed to display color images. Wherein, green fluorescent powder is arranged in the two diagonal grids, and red fluorescent powder and blue fluorescent powder are respectively arranged in the other two grids, for the excited light efficiency of the conventional green fluorescent powder is low. The grid marked as W in FIG. 4d can be coated with yellow fluorescent powder, the yellow light emitted by the yellow fluorescent powder and the rest blue light penetrating through the fluorescent powder are combined into white light, and the other three grids respectively are coated with red, blue and green fluorescent powder. FIGS. 4e-4h show the structures of a few other possible fluorescent powder repeating units, and the structures are more suitable for the application occasions of large screens and low pixels. Wherein, for example, FIG. 4h illustrates a repeating unit formed by a strip array using three strips as a period, in one period, at least one strip is provided with the optical wavelength conversion material for exciting green light, at least one strip is provided with the optical wavelength conversion material for exciting blue light, and at least one strip is provided with the optical wavelength conversion material for exciting red light.

The repeating units in every above embodiment can be periodically expanded and repeated on the optical wavelength conversion layer in two mutually orthogonal directions. The two mutually orthogonal directions can be respectively parallel to two orthogonal edges of the display region or crossed with the two orthogonal edges of the display region in a 45-degree angle. Because the excited light from fluorescent powder is isotropic, a black light absorption material is filled between the repeating units or between different grids or strips in the repeating units, so that the defect that the image contrast is reduced by mutual superposition of different color blocks can be avoided. The black light absorption material includes, but not limited to, carbon powder or graphite powder.

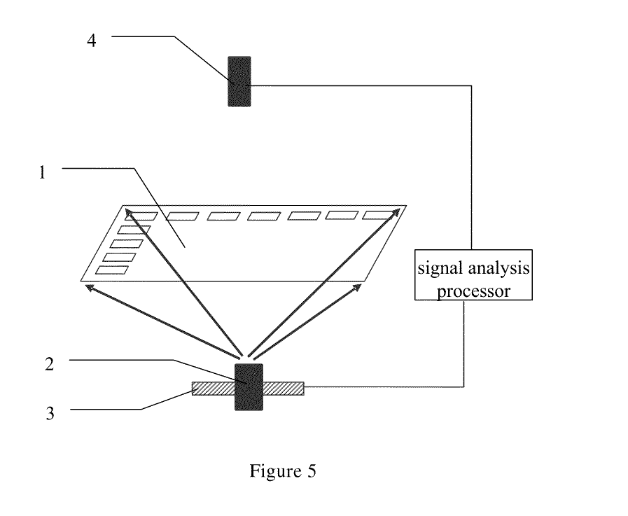

As shown in FIG. 5, the display device of the invention can further comprise at least one moving device 3 (such as, but not limited to, a precise motor), which is connected to projection device 2 and used for precisely adjusting the relative spatial positions of the projection device 2 and the display screen 1, and the projection pixels of the image carried by the exciting light are aligned with every repeating unit on the display screen 1 to improve the light exciting efficiency. Because the repeating units are periodically arranged, the moving range of the projection device 2 does not exceed the size range of one repeating unit, and the movement is required to be very precise.

When the projection pixels of the image carried by the exciting light are not aligned with the repeating units, irregular colors will be displayed on the display screen, so a calibration process is necessary to be periodically artificially or automatically implemented; and the calibration process can be designed by adopting the following steps:

a color or a brightness of the reproduced image in the projection region of the display screen generated by the projection device is acquired by using an optical sensor;
the color or the brightness is supplied to a signal analysis processor for calculating;
the light intensity distribution requirement of a projection light source of the projection device is determined according to the calculating result;
and a power supply source or a signal source supplied to the projection light source is controlled according to the light intensity distribution requirement; and
the spatial offset of the projection device is determined according to the calculating result, and the projection device is moved a small distance till the calculating result meets the requirement.

Therefore, a device can be designed as shown in FIG. 5 which comprises an optical sensor 4 and a signal analysis processor. Specifically, at least one optical sensor 4 is placed on one side of the display screen 1 opposite to the projection device 2 for acquiring the light color or the brightness of the display region; and the signal analysis processor is used for receiving the acquired signals from the optical sensor and outputting corresponding control signals to the moving device. The positions of a plurality of optical sensors 4 can be preset according to the actual requirement.

Seam processing when the display images of multiple projection devices are spliced can be implemented by using the structure of FIG. 5. As shown in FIG. 2, when the edges of two excited light images are partially (such as the region 112) superposed, the signal analysis processor outputs the corresponding control signals to every projection device by using the optical sensor 4 and the signal analysis processor in the embodiment of FIG. 5, the two images are smoothly transited at the superposed part and do not have mutation, zero width of seams can be realized, and the visual effect at the seams is better than that in the conventional method. Specifically, the projection device can be subjected to a calibration process of exciting light in the method, and the calibration process comprises the following steps:

the color or the brightness of the reproduced image of the projection device in the projection region on the display screen is acquired by using an optical sensor;
the color or the brightness is supplied to the signal analysis processor for calculating;
the light intensity distribution requirement of a projection light source of the projection device is determined according to the calculating result;
a signal source or a power supply source supplied to the projection light source is controlled according to the light intensity distribution requirement; and the control of the signal source comprises change of amplification factors of image signals, the control of the power supply source comprises change of power supply current or voltage, and the control belongs to the prior art and is not detailed here.

When the exciting light of every projection device is superposed in the projection region on the display screen, two or more projection devices corresponding to the superposed part can be subjected to the calibration process, so that the brightness and the color of the images excited by the combined light of the exciting lights of the superposed part realize smooth transition. For example, aiming at the region 112, the projection devices 21 and 22 are subjected to projection light source adjustment of the part, or one projection device is selected for the projection light source adjustment of the part, so that the total quantity of the exciting light of the part meets the requirements. When the aforementioned edge light design is adopted, the light intensity distribution requirement of the projection light source of the corresponding projection device is determined by combining the weakening mode of the edge light. In addition, when a special-shaped (such as annular or spherical) display screen is realized by using a flexible material such as transparent plastic as a base material, the exciting light calibration process is necessary.

For improving the display brightness, a first optical filter can be arranged in the optical path between the projection device and the display screen in the display device of the invention and used for transmitting the exciting light produced by the projection device and reflecting the excited light from the optical wavelength conversion layer. Preferably a second optical filter can be arranged on the opposite side of the display screen relative to the first optical filter and used for reflecting the exciting light from the projection device and transmitting the excited light from the optical wavelength conversion layer.

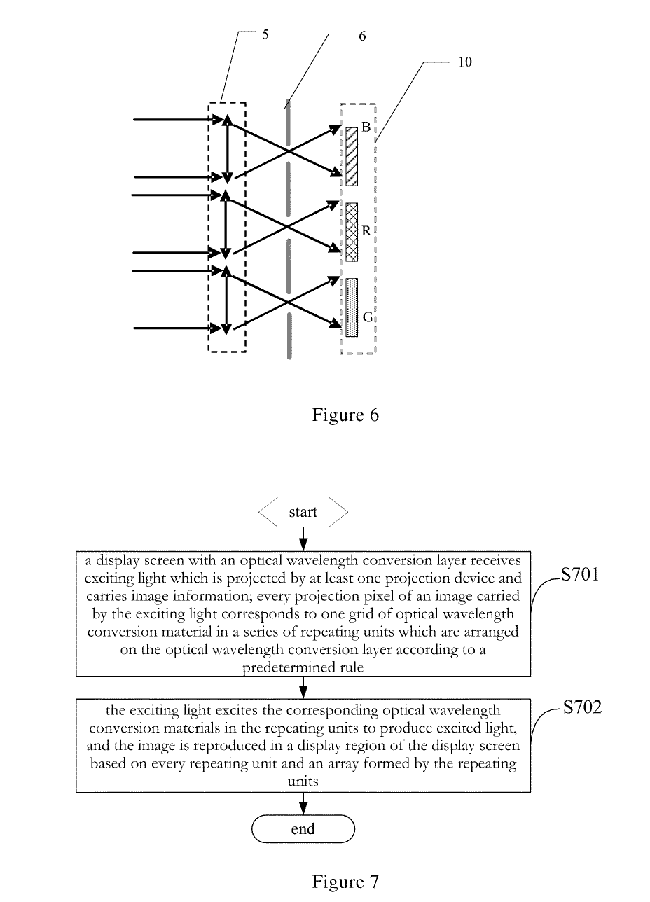

As shown in FIG. 6, for improving the light extracting efficiency of the fluorescent powder, a micro lens array 5 can be arranged close to the display screen in the optical path between the projection device and the optical wavelength conversion layer; and an exciting light is focused by each micro lens to at least one repeating unit 10 of the optical wavelength conversion material. An optical reflection material or a reflection film is coated or stuck to one side of the micro lens array 5 facing the optical wavelength conversion material, and the optical reflection material or the reflection film covers a part of area of the micro lens array 5, so that the utilization rate of the exciting light and the excited light which are not absorbed can be improved in the device of the present invention.

Furthermore, as shown in FIG. 6, the device of the invention can comprise a diaphragm 6 which is adjacent to the display screen and arranged in the optical path between the projection device and the optical wavelength conversion layer; apertures are periodically arranged on the diaphragm 6 and used for respectively corresponding to at least one repeating unit of the optical wavelength conversion material; and likewise, one side of the diaphragm facing the optical wavelength conversion layer can be set as a reflection surface.

Because the cost is high when the area of the optical filter is large, the micro lens array with the reflection film and/or the diaphragm with the reflection surface can replace the optical filter arranged on the same side as the projection device to transmit the exciting light and reflect most excited light of the fluorescent powder, so the cost is greatly reduced.

As shown in FIG. 7, based on the display device of the invention, the embodiment of the invention provides a display method, comprising:

S701, a display screen with an optical wavelength conversion layer receives exciting light which is projected by at least one projection device and carries image information; every projection pixel of an image carried by the exciting light corresponds to one grid of optical wavelength conversion material in a series of repeating units which are arranged on the optical wavelength conversion layer according to a predetermined rule;
and S702, the exciting light excites the corresponding optical wavelength conversion materials in the repeating units to produce excited light, and the image is reproduced in a display region of the display screen based on every repeating unit and an array formed by the repeating units.

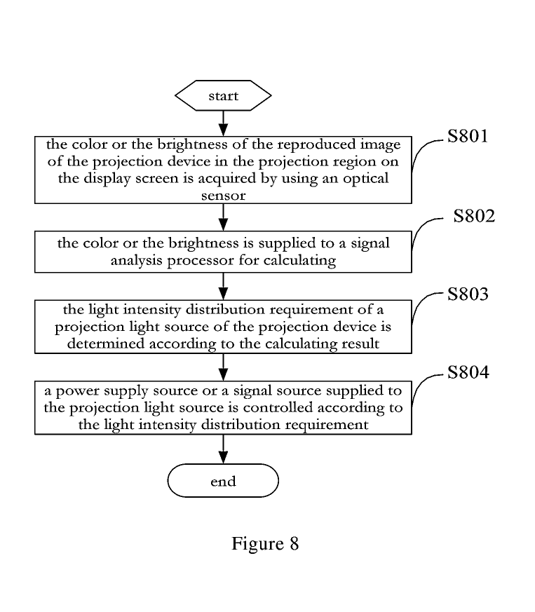

The display method further comprises a calibration process of the spatial position of every projection device and a calibration process of the exciting light of the every projection device when images are spliced.

Wherein: as shown in FIG. 8, the calibration process of the exciting light of the projection device comprises the following steps:

S801, the color or the brightness of the reproduced image of the projection device in the projection region on the display screen is acquired by using an optical sensor;
S802, the color or the brightness is supplied to a signal analysis processor for calculating;
S803, the light intensity distribution requirement of a projection light source of the projection device is determined according to the calculating result; and
S804, a power supply source or a signal source supplied to the projection light source is controlled according to the light intensity distribution requirement.

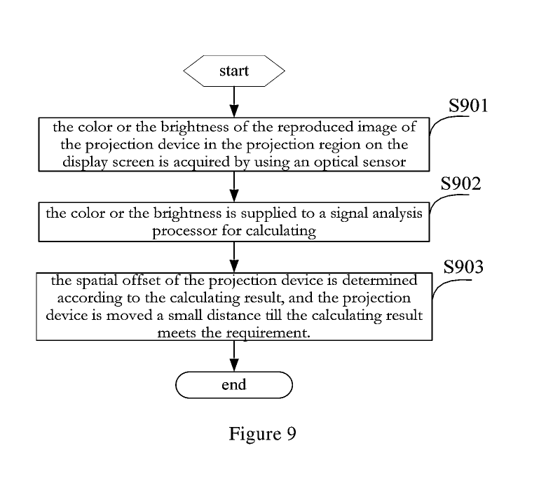

As shown in FIG. 9, the calibration process of the spatial position of the projection device comprises the following steps:

S901, the color or the brightness of the reproduced image of the projection device in the projection region on the display screen is acquired by using an optical sensor;
S902, the color or the brightness is supplied to a signal analysis processor for calculating; and
S903, the spatial offset of the projection device is determined according to the calculating result, and the projection device is moved a small distance till the calculating result meets the requirement.

In the calibration process of the projection device, the light intensity distribution requirement of the projection light source of the projection device is determined according to the calculating result and the preset brightness change mode of the projection device on the edge of the projection region of the display screen.

Experiments prove that a very mature fluorescent powder printing technology in a CRT (cathode ray picture tube) can be used in the display screen, so that the cost is very low. Meanwhile, a conventional projector can be conveniently used, so that the seamless splicing effect is extremely good. Particularly, the special-shaped display effect of the display screen is realized by using the method of the invention.

The above embodiments are only preferable embodiments of the invention, and are not intended to limit the protection scope of the invention. Equivalent structures or process flow modifications made by using the specification and the drawing contents of the invention, or direct or indirect applications in other related technical fields, are all included in the protection scope of the invention.

What is claimed is:

1. A display method, comprising the following steps:
a display screen provided with an optical wavelength conversion layer receives an exciting light which is projected by at least one projection device and carries image information; every projection pixel of an image carried by the exciting light corresponds to one unit of optical wavelength conversion material in a series of repeating units which are arranged on the optical wavelength conversion layer according to a predetermined rule; and
the exciting light excites the corresponding optical wavelength conversion materials in the repeating units to produce an excited light, and the image is reproduced in a display region of the display screen based on every repeating unit and an array formed by the repeating units.

2. The method of claim 1, further comprising:
a first optical filter in the optical path between the projection device and the display screen is used to transmit the light produced by the projection device and reflect the excited light from the optical wavelength conversion layer; and/or a second optical filter on the opposite side of the display screen relative to the first optical filter is used to reflect the exciting light from the projection device and transmit the excited light from the optical wavelength conversion layer.

3. The method of claim 1, further comprising:
the exciting light is focused by a micro lens array located in the optical path between the projection device and the optical wavelength conversion layer to at least one repeating unit through a corresponding micro lens, and the excited light from the optical wavelength conversion layer is reflected by an optical reflection material or a reflection film which is coated or stuck to one side of the micro lens array facing the optical wavelength conversion material.

4. The method of claim 1, further comprising:
the exciting light is focused by a diaphragm located in the optical path between the projection device and the optical wavelength conversion layer to at least one corresponding repeating unit, and the excited light from the optical wavelength conversion layer is reflected by a reflection surface on one side of the diaphragm facing the optical wavelength conversion layer.

5. The method of claim 1, wherein the brightness information of every projection pixel of the image carried by the exciting light is controlled through an optical valve in the projection device and used for determining the brightness of the excited light of the corresponding optical wavelength conversion material in the repeating unit.

6. The method of claim 1, wherein, when the number of the projection devices is two or more, the exciting light of every projection device is respectively projected to the same display region of the display screen; or the exciting light of every projection device is respectively projected to a local part of the display screen, and images reproduced on the local parts are spliced or superposed into an image.

7. The method of claim 6, wherein the display brightness of the display screen is calculated according to a predetermined algorithm, so that the display brightness linearly or nonlinearly changes in the centrifugal direction of the center of a circumscribed circle of the projection range.

8. The method of claim 1, further comprising a calibration process of the exciting light of the projection device, wherein the calibration process comprises the following steps:
a color or a brightness of the reproduced image in the projection region of the display screen generated by the projection device is acquired by using an optical sensor;
the color or the brightness is supplied to a signal analysis processor for calculating;
a light intensity distribution requirement of a projection light source of the projection device is determined according to the calculating result; and
a power supply source or a signal source supplied to the projection light source is controlled according to the light intensity distribution requirement.

9. The method of claim 1, further comprising a calibration process of a spatial position of the projection device, wherein the calibration process comprises the following steps:
a color or a brightness of the reproduced image in the projection region of the display screen generated by the projection device is acquired by using an optical sensor;
the color or the brightness is supplied to a signal analysis processor for calculating;
and a spatial offset of the projection device is determined according to the calculating result, and the projection device is moved a small distance till the calculating result meets the requirement.

10. A display device, comprising a display screen and at least one projection device, wherein the projection device projects an exciting light which carries image information to the display screen, a display region of the display screen is provided with an optical wavelength conversion layer, at least one type of optical wavelength conversion material, when being excited by the exciting light, able to produce a visible excited light is arranged on the optical wavelength conversion layer, and the optical wavelength conversion materials are arranged according to a predetermined rule to form a series of repeating units for reproducing images on the display region.

11. The display device of claim 10, further comprising a first optical filter arranged in the optical path between the projection device and the display screen and used for transmitting the exciting light produced by the projection device and reflecting the excited light from an optical wavelength conversion layer; and/or a second optical filter arranged on the opposite side of the display screen relative to the first optical filter and used for reflecting the exciting light from the projection device and transmitting the excited light from the optical wavelength conversion layer.

12. The display device of claim 10, further comprising a micro lens array located in the optical path between the projection device and the optical wavelength conversion layer; the exciting light is focused by the micro lens array to at least one repeating unit through a corresponding micro lens, and an optical reflection material or a reflection film is coated or stuck to one side of the micro lens array facing the optical wavelength conversion material.

13. The display device of claim 10, further comprising a diaphragm which is adjacent to the display screen and is arranged in the optical path between the projection device and the optical wavelength conversion layer; open pores are periodically arranged on the diaphragm and used for respectively corresponding to at least one repeating unit of the optical wavelength conversion material; and one side of the diaphragm facing the optical wavelength conversion layer is a reflection surface.

14. The display device of claim 10, wherein the projection device is a projector using a blue light emitting diode (LED) and/or ultraviolet LED and/or blue laser and/or ultraviolet laser as a light source.

15. The display device of claim 10, wherein, when the number of the projection devices is two or more, the exciting light of each of the projection devices is respectively projected to the same display region of the display screen; or the exciting light of each of the projection devices is respectively projected to a local part of the display screen, and images reproduced on the local parts are spliced or superposed into an image.

16. The display device of claim 10, wherein the repeating units are periodically expanded and repeated in two mutually orthogonal directions on the optical wavelength conversion layer.

17. The display device of claim 10, wherein a black light absorption material is filled among the repeating units or among different grids or strips in the repeating units.

18. The display device of claim 10, wherein, when the exciting light of the projection device is a blue light, the grid or the strip marked for bearing blue light in every repeating unit is a transparent substrate or/and a scattering material.

19. The display device of claim 10, further comprising at least one moving device which is connected and attached to the projection device and used for precisely adjusting relative spatial positions of the projection device and the display screen.

20. The display device of claim 10, wherein the display screen is provided with a substrate made of a flexible material.
